(19) United States
(12) Patent Application Publication
(10) Pub. No.: US 2003/0176101 A1
(43) Pub. Date: Sep. 18, 2003

(54) Power block

(76) Inventor: Donald J. E. Miller JR., Tampa, FL (US)

Correspondence Address: Donald J. E. Miller, Jr., 6509 Secrest Ct, Tampa, FL, 33625, US

(21) Appl. No.: 10/358,434

(22) Filed: Feb. 4, 2003

Related U.S. Application Data
(63) Continuation-in-part of application No. 09/973,542, filed on Oct. 9, 2001, now abandoned.

(51) Int. Cl. H01R 13/60

(52) U.S. Cl. 439/535

(57) ABSTRACT

Power Block is an ac adapter system that plugs into a wall socket, with rocker switches that turn off and on ac outlets on the block. The power block also incorporates a nightlight built into the system, and an air freshener also built in.

| | |
|---|---|
| Inventor: | Donald J. E. Miller, Jr.; (U.S.) |
| Residence: | 6509 Secrest Ct |
| | Tampa, FL 33625 |
| Title: | Power Block |

Continuation In Part to U.S. application Ser. No. 09/973,542.

### FIELD OF THE INVENTION

The power block relates to ac adapters, Plugging into the wall socket and having extra outlets, and switches to turn off and on each individual outlet. The power block incorporates a nightlight and air freshener.

### BACKGROUND OF THE INVENTION

An adaptors body can plug into a wall socket and have multiple outlets, if there is a nightlight and air freshener in the wall socket they'll have to be removed, or the nightlight and air freshener can be plugged into the wall adapter but that will take up outlet space. The power block incorporates all these items into one adapter, allowing a nightlight and air freshener to be used and still have outlets free.

### SUMMARY OF THE INVENTION

The power block is an ac adapter that plugs into an ac outlet. There are rocker switches on the block that are connected to the outlets allowing each outlet to be turned off and on independently. So a computer system can be turned off and yet the television can still be watched, and if there are power strips pluged to the power block and thear behind a desk or dresser it can still be turn off and on from the power block. There is a nightlight built into the power block and the light itself slips into a cup on the front of the block, this makes it a little more secure to the point that there's no plastic cover sticking up to get knocked off or a thin light bulb that could get broke, and the nightlight comes with its own switch. An air freshener is also built into the power block with the fragrance holder being placed in its housing on the front of the block and locked in place by giving the holder a slight turn.

### DESCRIPTION OF DRAWINGS

Page 1. Is the completed Power Block.

Page 2. Is the front and inside back of the power block body.

Page 3. Is the positive, negative prong and grounder prong and the nightlights tubing and ring plus the positive, negative and grounder strips and the back of the air freshener cup.

Page 4. Is the front view of the ac outlet, rocker switch and the nightlights on and off switch.

Page 5. Is the nightlight with the front and back view, plus the inside front, the cover and its wires and connecters. And a view of the finished light cut in half.

Page 6. Is the air freshener from the front and back, also shown is the front cover and the back cover. The front covers adhesive sealer and the finished air freshener cut in half.

Page 7. Is the inside back of the power block in its completed state, also shown is the back of the block.

It is to be understood that the present invention is not limited to the details of construction and arrangement of parts illustrated in the accompanying drawings, since the invention is capable of other embodiments, and is capable of being practiced or carried out in various ways within the scope of the claims. Also, it is to be understood, that the phraseology and terminology employed herein is for the purpose of description, and not of limitation.

### DESCRIPTION OF INVENTION

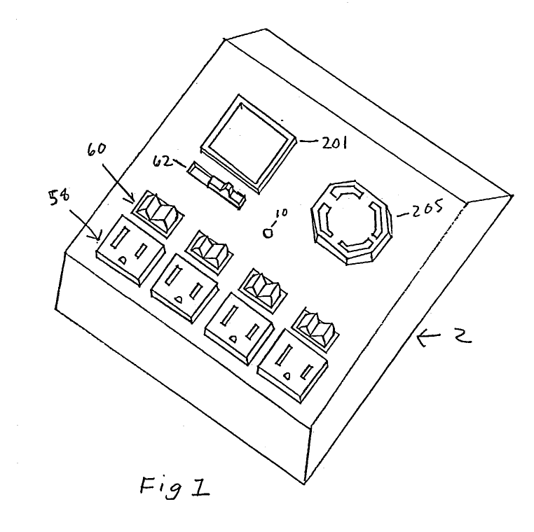

FIG. 1 shows a perspective of the Power Block, designated by the number 2, it's an ac adapter with a nightlight and an air freshener, and ac outlets. It has rocker switches that turn off and on the ac outlets on the block.

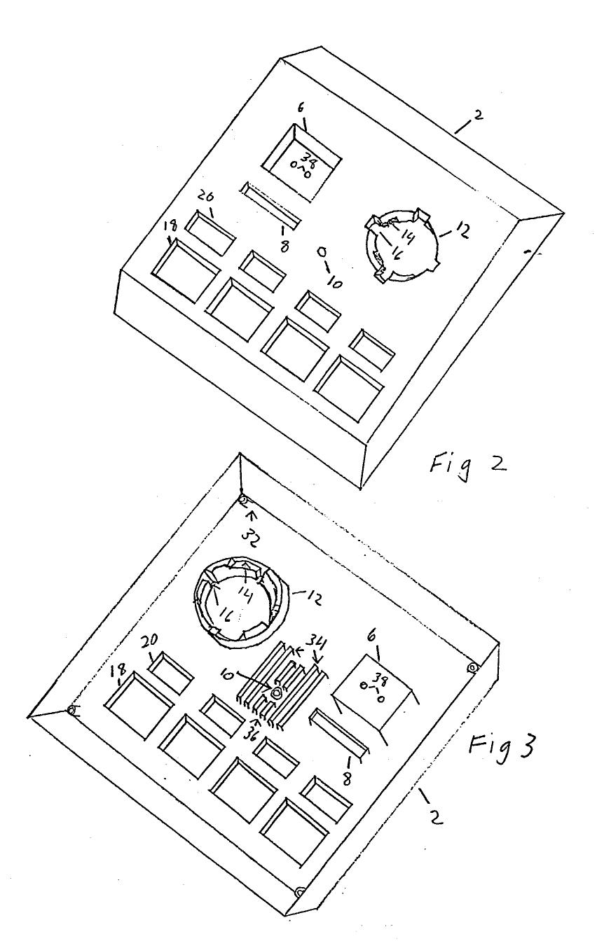

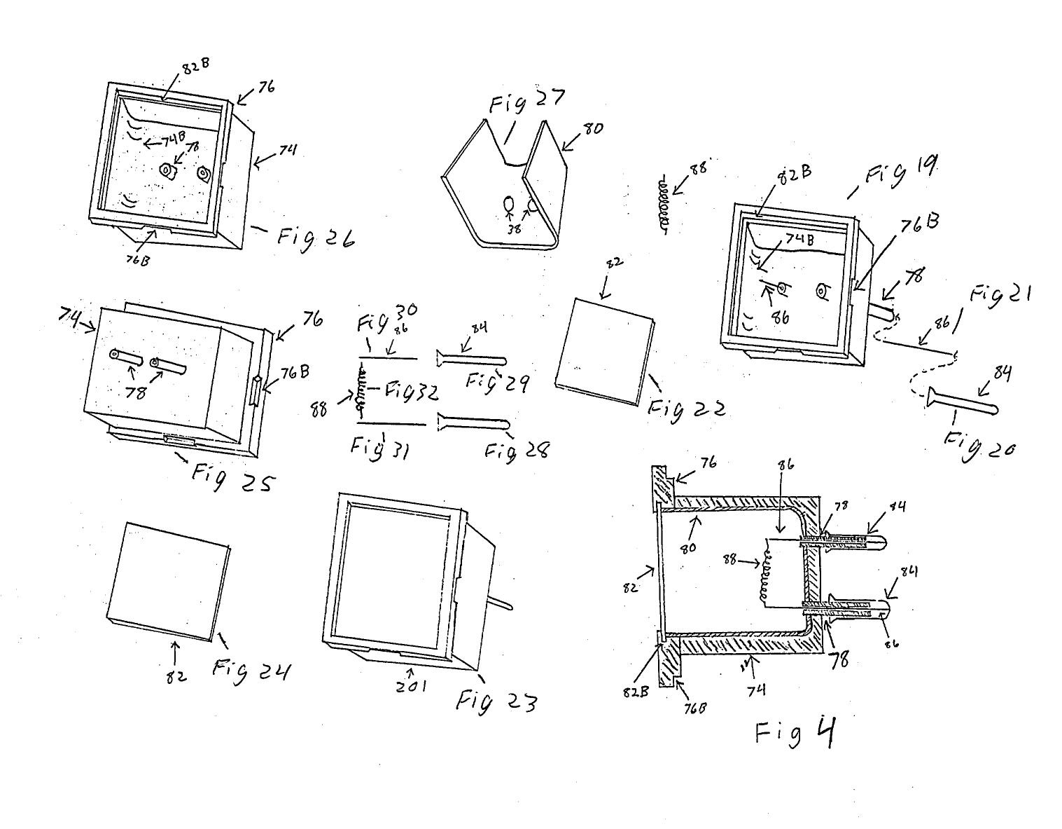

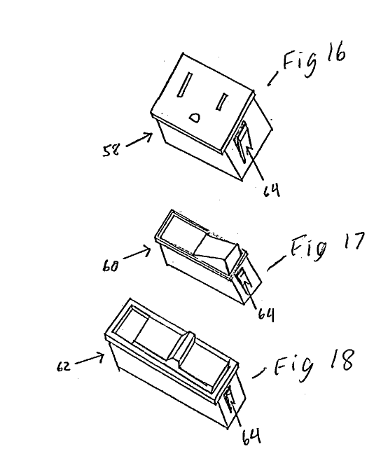

Page 2, showing the body of the power block from the front and from the inside back. The body is a square block made of plastic, with the top and bottom at a 20-degree angle and the sides are strait up and down. On the bottom of the block FIG. 2, just above the ac outlet holes 18 are rectangular holes 20 that the rocker switches 60 fit in, and at the bottom of these are square ac outlet holes 18. At the top left of the power block is a nigbtlight cup 6, and it goes in at the front and protrudes out the back FIGS. 3, 6 and in the center of this cup are two holes that will hold the power tubes 136 for the nightlight. FIG. 2, under the nightlight is a rectangular slot 8 that holds the nightlight switch 62, and to the right of the switch is the center hole 10 that secures the power block to the wall socket. Across from the nightlight cup at top right on the power block is the air freshener tube 12, it's round with four square groves that start at the front of the cup and extend the length of the tube 16 and at the back of the tube are four slots that extend to the right, half way 14 before reaching the next extended grove. Turning the power block around and looking inside FIG. 3, are the protruding nightlight box 6, air freshener cup 12. And in the center of the power block encircling the blocks center screw hole 10 are the three sets of power prong grids 34, 36, the grids are plastic strips and hold the positive and negative prongs 46, and the center grids hold the grounder prongs 48, and the center grids 36 are in two sections with each section being placed at the top and bottom of the blocks secure hole 10. At each corner of the power block is a round peg with a hole in the center 32, these are for the blocks back panel 68. The back of the power block is a square piece of sturdy plastic 68 with four holes in each corner 134, and two negative and two positive prong slots in the center 70, with two grounder holes 72, and in the center of these is the blocks screw hole 10.

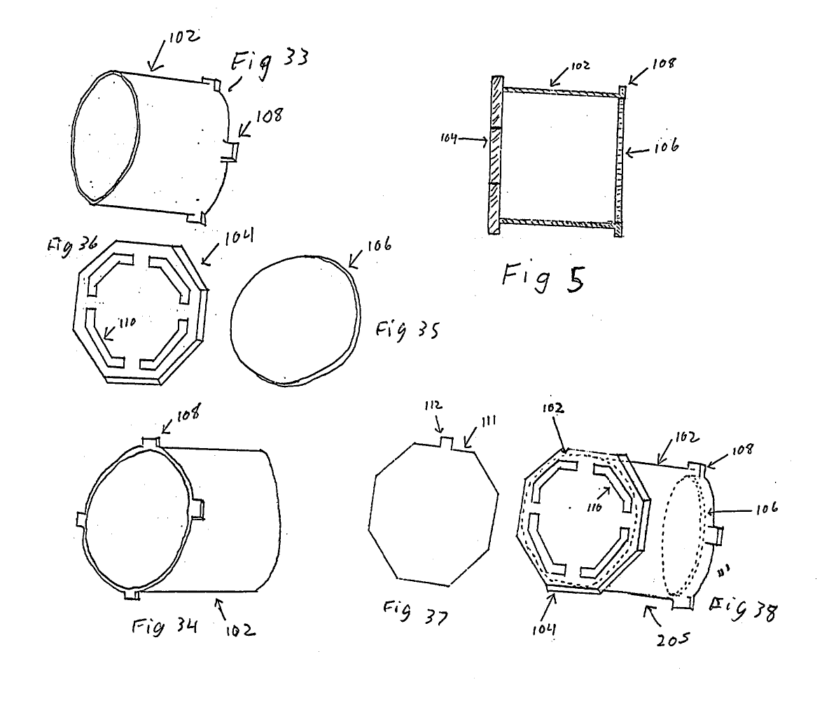

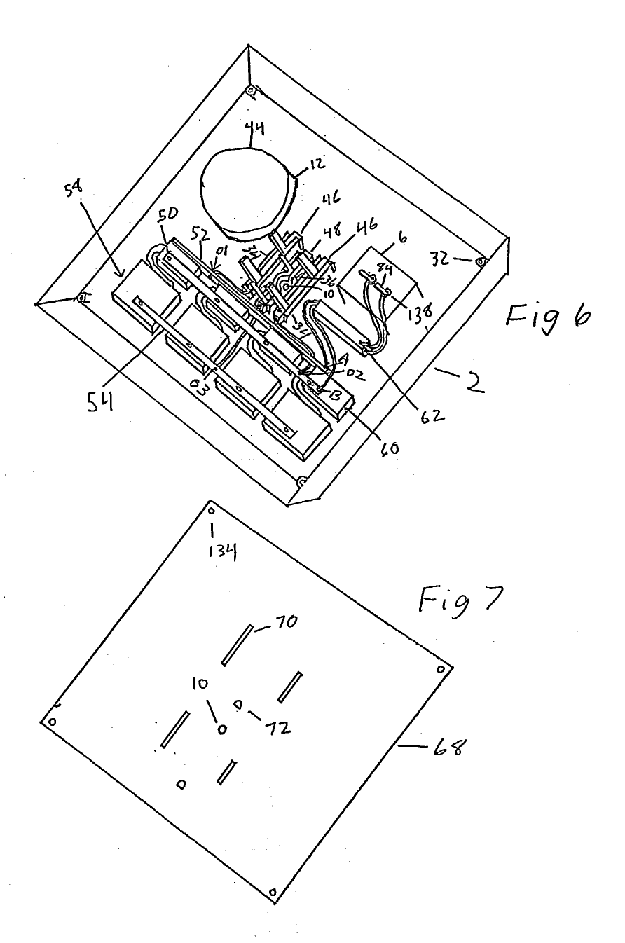

The making of the power block begins with the nightlight on page 4. FIG. 4, shows the nightlight cut in half, starting with the body of the nightlight being made of plastic 74, the outside is a square block, but the inside left and right corners are rounded 74b and in the center of the back are two thin tubes spaced side by side sticking a short way out in the front, and a bit longer out the back 78. Next is the reflector 80 which is made of a mirror foil, it's a thin strip of metal that's bent in a square shape with the back corners also rounded, there are two holes in the center back 38. The reflector foil is placed in the nightlight body with the tubes in the nightlight body 78 fitting through the holes in the back of the foil 38. Then take the nightlights metal tube cup 84 and place the light wires 86 into the cups and secure them with solder or some form of adhesive, then slide the light wires through the holes of the nightlights body tubes 78 from the back and slide them up till the plastic body tubes 78 are resting at the back of the metal tube cups 84, securing the metal tube cups to the plastic body tubes with adhesive. In the front of the nightlight the two light wires that where slipped into the body's tubes 78 from the back should be seen protruding from the holes of the body's tubes inside of the nightlight. Place the nightlight coil 88 between the two light wires 86 sticking out of the plastic tubes inside of the nightlight body, and secure one end of the coil to one wire and the other end to the other wire. The rim of the nightlight is a square plastic frame with four small rectangular slots on all four sides 76b, these slots allow the nightlight to be pride from its home to be replaced. Along the inside of the rim is a thin grove for the nightlight cover 82 a thin white sheet of sturdy square plastic. The light cover 82 is placed in the groves 82b of the nightlight rim 76 and secured with adhesive such as liquid rubber, the rim is then connected to the front of the nightlight body 74 with a epoxy or adhesive. The nightlight is now air tight and ready to be placed in the power block; the finished nightlight is shown to the left of FIG. 4, 201.

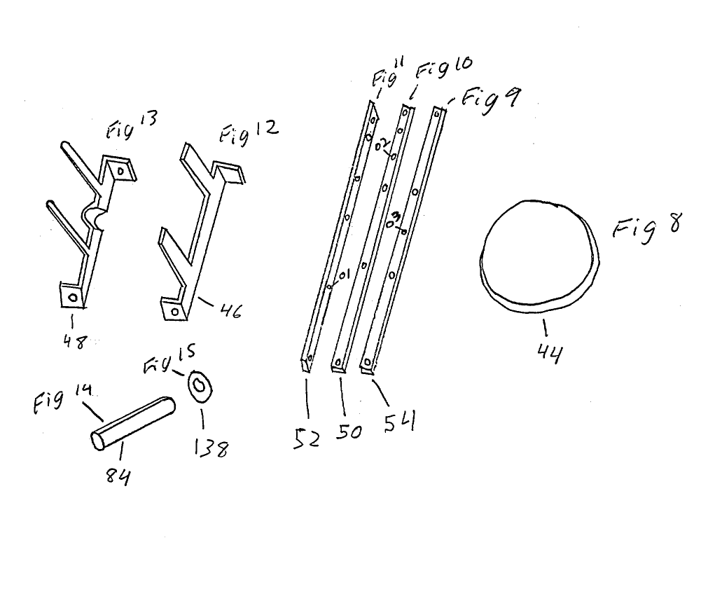

Next is the air freshener page 5, 205 shows the completed air freshener and FIG. 5, shows the freshener holder cut in half. The air freshener is made of clear plastic, the body being a round tube 102 with four square pegs 108 on four sides. The back of the freshener is a round disc 106 and goes into the back of the air freshener tube and sealed with an adhesive such as glue. The front part of the air freshener is a octoangular shaped lid 104 with four air slots around the center of the lid 110, and it goes on the front of the freshener cup after the fragrance jell is placed in the cup. The protective cover for the freshener is a very thin octoangular shape piece of plastic with adhesive on one side and a peeler flap at the top 112, and is stuck to the front of the air freshener lid 104 covering the air slots 110 protecting the jells fragrance from escaping.

The next step to putting the block together is with the front of the power block FIG. 2, placing the rocker switches 60 in there holes 20 and snap them in place, then take the ac outlets 58 and put them in there holes 18 locking them in place. The rocker switches, outlets and nightlight switch are held in place by side latches 64, the nightlight switch 62 is then snapped into its hole 8. The nightlights power tubes 136 are then placed in the holes at the back of the nightlight box 38, turn the block over and inside FIG. 6 page 7, place the rings 138 for the nightlight tubes 136 over the tubes and slide them down until their flat against the light box and secured with solder or other adhesive. The positive and negative prong strips are the same 46, it's a strip of metal with two prongs sticking out from the side, and the metal strip is bent at the top and bottom to keep it from sliding out of its plastic grids and there is a hole in the bottom of the strip. And the grounder prong strip 48 is made about the same except the strip is curved in the center to make room for the power blocks screw hole 10, and it has the round prongs sticking from the side. The positive and negative prong strips are placed in their left and right center strips 34 and the ground prong strip is placed in its center strips 36.

The positive strip 52 is a strait strip of metal with six holes in the side, and is placed on the top of the rocker switches 60 and four of the holes are connected to each switches positive grid with solder. The negative strip 50 is the same as the positive strip, except there are six holes through it, and the negative strip is placed on the lower back side of the rocker switches and four holes on the strip are connected to each switches negative grid. The grounder strip 54 is also a strait strip of metal and it has five holes in it. Four of the holes connect to the grounding grids on the lower back of the outlets 58.

The back of the air freshener cup 12 is a simple round plastic disc 44 that covers the entire back of the freshener cup and held in place with a adhesive or glue. The positive and negative prong strips are the same 46, it's a strip of metal with two prongs sticking out from the side, and the metal strip is bent at the top and bottom to keep it from sliding out of its plastic grids and there is a hole in the bottom of the strip. And the grounder prong strip 48 is made about the same except the strip is curved in the center to make room for the power blocks screw hole 10, and it has the round prongs sticking from the side. The positive and negative prong strips are placed in their left and right center strips 34 and the ground prong strip is placed in its center strips 36.

Take and connect a strip of wire to the bottom of positive prong strip 46 and connect a strip of wire to the bottom of negative prong strip 46. Then take the positive prong wire and connect it to the unused hole on the positive strip 01, then take the negative prong wire and do the same connecting it to the unused hole on the negative strip 02. A third wire is connected to the bottom of the grounder prong strip 48 and it's connected to the center hole on the grounder strip 03. A strip of wire is then connected to the unused hole at the end of the positive prong strip A and another strip of wire is connected to the end hole on the negative prong strip B. The other end of the positive A wire and the negative B wire are extended up to the light switch where they're connected to the positive and negative grids of the nightlight switch 62. Two more wires from the other side of the light switch are then connected to the nightlight tubes 136 and tube rings 138 on the back of the nightlight box 6. Taking eight more wires the lengths being the same, and connecting a wire to each of the four rocker switches 60 positive grid and connect the other four wires to the negative grid on each rocker switch.

Each of the positive wires on the rocker switches are then connected to each ac outlets 58 positive grid, and each rocker switches negative wire connects to each of the ac outlets negative grids. The back of the power block 68 is now screwed onto the back finishing the power block.

01. A ac adapter system that allows ac outlets on the system to be individually turned off or on by rocker switches on the system.

02. A ac adapter system according to claim 1, wherein said a nightlight cup built into the body of said system, to house the systems own nightlight and a on and off switch for the light.

03. A ac adapter system according to claim 1, wherein said having an air freshener cup built into the system, to hold the adapters air freshener.
